(19) United States
(12) Patent Application Publication
(10) Pub. No.: US 2007/0252914 A1
(43) Pub. Date: Nov. 1, 2007

(54) Y/C separation apparatus

(75) Inventors: Shigeki Kamimura, Tsurugashima-shi (JP); Yuichi Honda, Fukaya-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHKI KAISHA TOSHIBA, Tokyo (JP)

(21) Appl. No.: 11/790,583

(22) Filed: Apr. 26, 2007

(30) Foreign Application Priority Data
Apr. 28, 2006 (JP) 2006-126967

(51) Int. Cl. H04N 9/77

(52) U.S. Cl. 348/663

(57) ABSTRACT

According to one embodiment, a Y/C separation apparatus executes a Y/C separation based on a difference between frames of a composite video signal. The Y/C separation apparatus includes: a motion detection unit that specifies a motion amount based on an amount of a two-frame difference or one-frame difference at each of target pixels; and a determination unit that determines if an image is still based on a motion detection result of the motion detection unit. The motion detection unit detects differences for pixels adjacent to the target pixels.

### CROSS-REFERENCE TO RELATED APPLICATIONS

This application is based upon and claims the benefit of priority from Japanese Patent Application No. 2006-126967, filed Apr. 28, 2006, the entire contents of which are incorporated herein by reference.

### BACKGROUND

1. Field

One embodiment of the invention relates to a Y/C separation apparatus in a television receiver and in particular to a Y/C separation motion detection circuit.

2. Description of the Related Art

In recent years, often, motion of a screen in a frame or between frames of the screen displayed on a television (TV) receiver has been detected for putting it to work on processing of conversion to high image quality.

For example, hitherto, an art has been known wherein when a video signal of interlaced scanning is subjected to intrafield interpolation, the feature that each interpolation pixel should have is precisely determined from the feature of the current pixel in the neighbor. (For example, refer to JP-A-2005-341346) However, this art is described as a determination is made so that the feature that each interpolation pixel should have can be distinguished from a slating direction edge.

That is, the art is not an art that can perform general processing of conversion to high image quality in a Y/C separation circuit, for example; this is a problem.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram of a Y/C separation motion detection circuit according to an embodiment of the invention;

FIG. 2 is a diagram showing a main signal processing system of the Y/C separation motion detection circuit;

FIG. 3 is a drawing describing the operation of the embodiment of the main signal processing system of the Y/C separation motion detection circuit;

FIG. 4 is a drawing describing conversion of motion amount to selection value in the embodiment . . . according to the first embodiment;

FIG. 5 is a drawing showing a MIX circuit example in the embodiment;

FIG. 6 is a drawing to show a magnitude comparison circuit example in the embodiment;

FIG. 7 is a function schematic representation of the embodiment;

FIG. 8 is a second drawing to describe the operation of an embodiment of the main signal processing system of the Y/C separation motion detection circuit; and

FIG. 9 is a third drawing to describe the operation of an embodiment of the main signal processing system of the Y/C separation motion detection circuit.

### DETAILED DESCRIPTION

Various embodiments according to the invention will be described hereinafter with reference to the accompanying drawings. In general, according to one embodiment of the invention, a Y/C separation apparatus for executing a Y/C separation based on a difference between frames of a composite video signal, includes a motion detection unit that specifies a motion amount based on an amount of a two-frame difference or one-frame difference at each of target pixels; and a determination unit that determines if an image is still based on a motion detection result of the motion detection unit; wherein the motion detection unit detects differences for pixels adjacent to the target pixels.

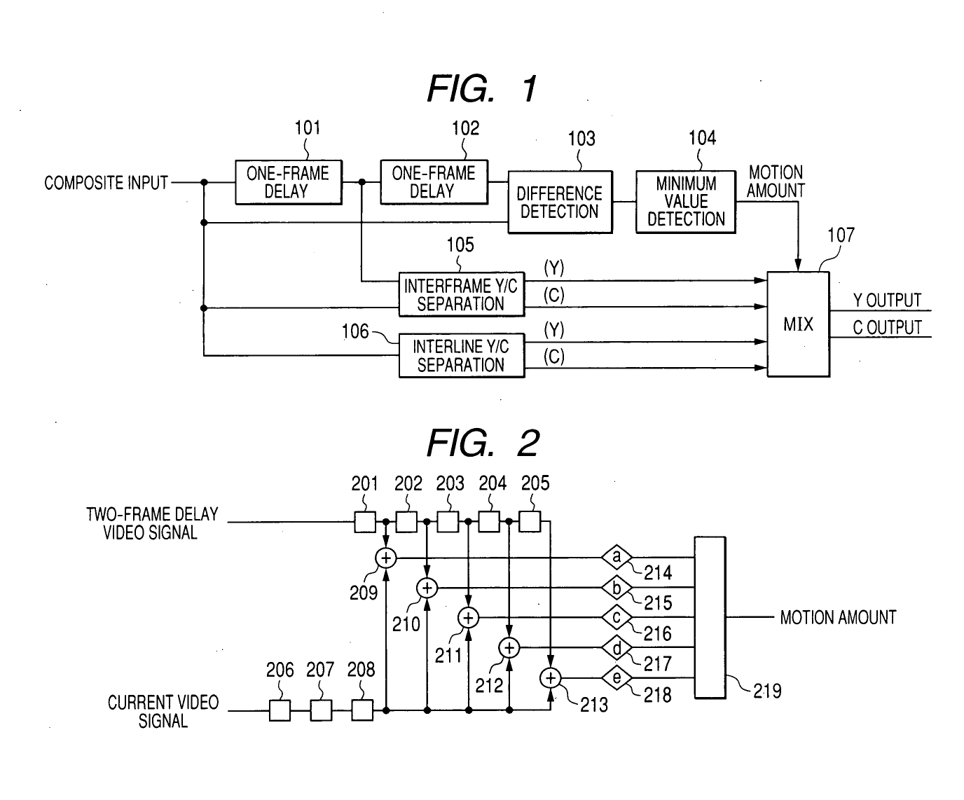

A first embodiment of the invention will be discussed with reference to FIGS. 1 to 7.

FIG. 1 is a block diagram of a Y/C separation motion detection circuit incorporating the invention. One-frame delays 101 and 102 are circuits for delaying one-frame video; the one-frame delay 101 inputs a composite video signal given from the outside and feeds the delay result of the signal into the one-frame delay 102. The one-frame delay 102 outputs the result of delaying that delay result.

Difference detection 103 inputs the output of the one-frame delay 102 and the composite video signal and outputs the difference detection result. Minimum value detection 104 inputs the output of the difference detection 103 and outputs a motion amount described later. An interframe Y/C separation circuit 105 inputs the composite video signal and the output of the one-frame delay 101 and outputs a luminance signal (Y) and a chrominance signal (C). An interline Y/C separation circuit 106 inputs the composite video signal and outputs a luminance signal (Y) and a chrominance signal (C). A MIX circuit 107 inputs the luminance signal (Y) and the chrominance signal (C) output by the interframe Y/C separation circuit 105 and the luminance signal (Y) and the chrominance signal (C) output by the interline Y/C separation circuit 106 and also inputs the motion amount output by the minimum value detection 104, and outputs a luminance signal) and a chrominance signal.

FIG. 2 is a diagram to show a main signal processing system of the Y/C separation motion detection circuit, namely, specific circuits of the difference detection 103 and the minimum value detection 104.

Numerals 201, 202, 203, 204, 205, 206, 207, and 208 denote latch circuits. Numeral 209 denotes an operator for computing the output difference between 201 and 208; numeral 210 denotes an operator for computing the output difference between 202 and 208; numeral 211 denotes an operator for computing the output difference between 203 and 208; numeral 212 denotes an operator for computing the output difference between 204 and 208; and numeral 213 denotes an operator for computing the output difference between 205 and 208.

A video signal with two-frame delay is input to 201 and the current video signal is input to 206. The operator 209 computes the difference between a video signal with two-frame delay+one-clock delay and a video signal as the current video signal+three-clock delay, and outputs the difference as the motion amount. The operator 211 computes the difference between a video signal with two-frame delay+two-clock delay and a video signal as the current video signal+three-clock delay, and outputs the difference as the motion amount. The operator 211 computes the difference between a video signal with two-frame delay+three-clock delay and a video signal as the current video signal+three-clock delay, and outputs the difference as the motion amount. The operator 212 computes the difference between a video signal with two-frame delay+four-clock delay and a video signal as the current video signal+three-clock delay, and outputs the difference as the motion amount. The operator 213 computes the difference between a video signal with two-frame delay+five-clock delay and a video signal as the current video signal+three-clock delay, and outputs the difference as the motion amount. This means that the difference between the video signal as the current video signal+three-clock delay and the video signal preceding two frames two clocks is detected.

214 to 218 have coefficients of a, b, c, d, and e respectively and multiply the operator outputs of 209 to 213 by the coefficients. Numeral 219 denotes a circuit for detecting the minimum value from outputs of 214 to 218. The weighting parts of 214 to 218 may be contained in the difference detection circuit 103 or may be contained in the minimum value detection 104 circuit.

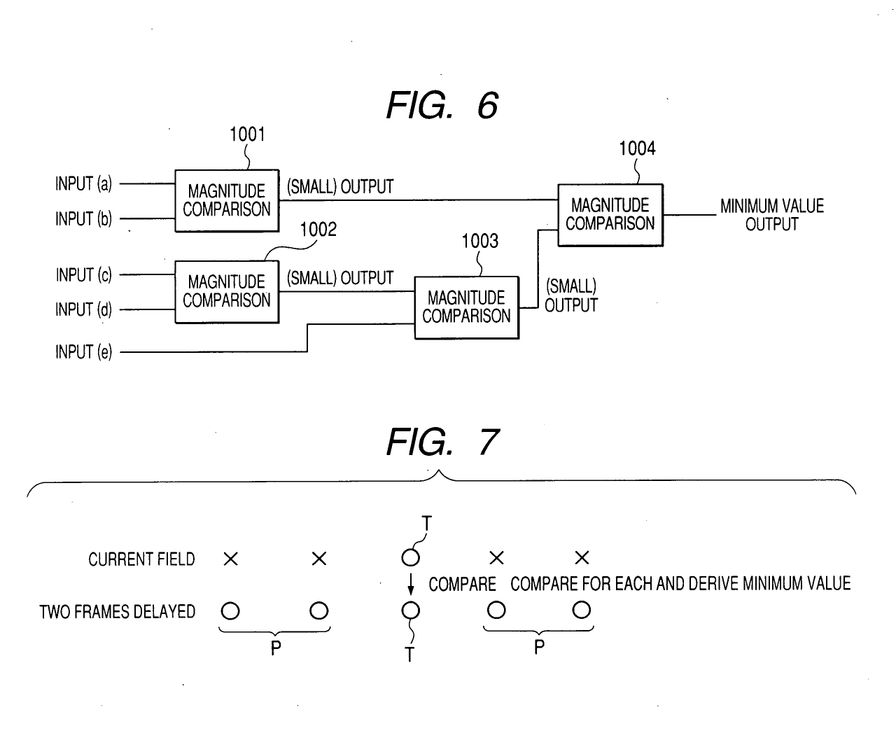

A specific circuit example of 219 is shown in a magnitude comparison circuit example of the embodiment in FIG. 6. Magnitude comparison circuits 1001 to 1004 are included and the minimum value is derived from inputs (a), (b), (c), (d), and (e). The coefficients of a, b, c, d, and e in FIG. 2 can be set to various values.

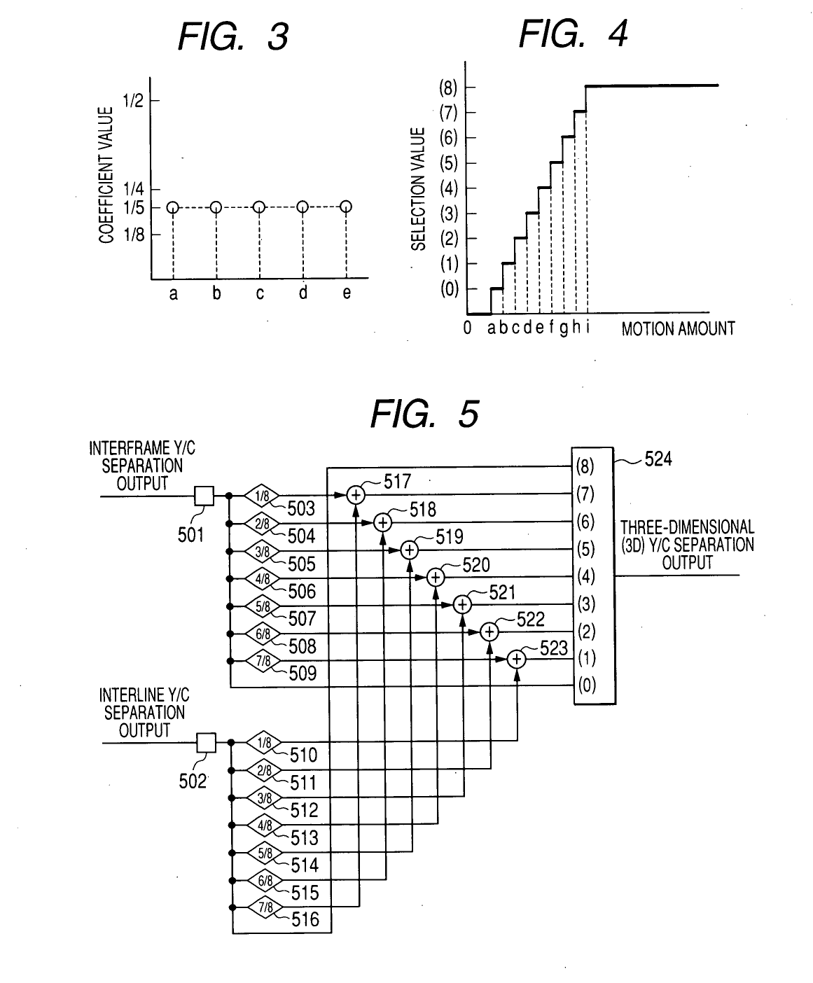

FIG. 3 is a drawing to describe the operation of an embodiment of the main signal processing system of the Y/C separation motion detection circuit. It shows that the coefficients a, b, c, d, and e are set to the same value in FIG. 2.

FIG. 4 is a drawing to describe conversion of motion amount to selection value in the embodiment for use in the MIX circuit described below. FIG. 5 is a drawing to show a MIX circuit example in the embodiment. Numeral 501 denotes a circuit for latching interframe Y/C separation output, and numeral 502 denotes a circuit for latching interline Y/C separation output. Numerals 503 to 509 denote coefficient circuits for multiplying output of the circuit 501 by seven types of coefficients. Numerals 510 to 516 denote coefficient circuits for multiplying output of the circuit 502 by seven types of coefficients.

Numerals 517 to 523 denote operators for performing operations on the outputs of the coefficient circuits, and numeral 524 denotes a selector circuit for selecting and outputting any of the outputs of the operators 517 to 523. The selector circuit 524 selects any signal from among the signals output from the operators based on the motion amount output from 104.

At this time, the motion amount and the selection value have the relationship as shown in FIG. 4; the motion amount is converted into any of nine selection values in such a manner that if the motion amount is a value of 0 to a (for example, equal to or greater than 0 and less than a), it is converted into selection value 1 or that if the motion amount is a value of a to b, it is converted into selection value 2. If the motion amount is large, the selection value is large; if the motion amount is small, the selection value is small. Therefore, the ratio of the interline Y/C separation output becomes high where video changes and the motion amount is large between two frames; the ratio of the interframe Y/C separation output becomes high in a portion of video close to a still image with small motion amount.

In a screen where motion is small close to a still image, the ratio of the interframe Y/C separation is increased, whereby interference such as cross color interference caused to occur as a luminance signal affects a chrominance signal or dot interference caused to occur as a chrominance signal affects a luminance signal can be lessened as much as possible. However, if interframe Y/C separation is executed in video with large motion amount, the video becomes a double image and a screen failure occurs, in which case the ratio of the interline Y/C separation is increased.

However, cross color interference and dot interference often occur in the interline Y/C separation and thus the image quality as the screen is degraded.

FIG. 6 is a drawing to show a magnitude comparison circuit example in the embodiment. The magnitude comparison circuits 1001 to 1004 are included and the minimum value is derived from inputs (a), (b), (c), (d), and (e).

FIG. 7 is a function schematic representation of the embodiment. By using the difference detection circuit 103 shown in FIG. 2, the target pixel T in the current field is compared not only with the target pixel T but with the pixels P adjacent to the target pixel T in the field two-frames delayed from the current field so as to obtain the differences therebetween. These differences are weighted or unweighted at the circuits 214-218 to be output to the circuit 219 in FIG. 2. At the circuit 219, the minimum value of the weighted/unweighted differences is detected.

To detect the motion amount, if the motion amount is derived by finding the difference for each pixel, the motion amount is determined large even in slow screen pan feeling like that the screen does not much move, and the ratio of the interline Y/C separation becomes high, causing cross color interference and dot interference to often occur.

In the embodiment, the motion amount is detected as small in a screen like slow screen pan, whereby the ratio of the interframe Y/C separation becomes high as much as possible. Although the possibility of a screen failure of a double image occurs as the ratio of the interframe Y/C separation is increased for a moving image screen, of course, coefficient adjustment is made so as to execute motion detection in the range in which it cannot be determined a double image as visual sense.

### Second Embodiment

A second embodiment of the invention will be discussed with reference to FIGS. 1, 2, and 4 to 9. Parts similar to those in the first embodiment will not be discussed again.

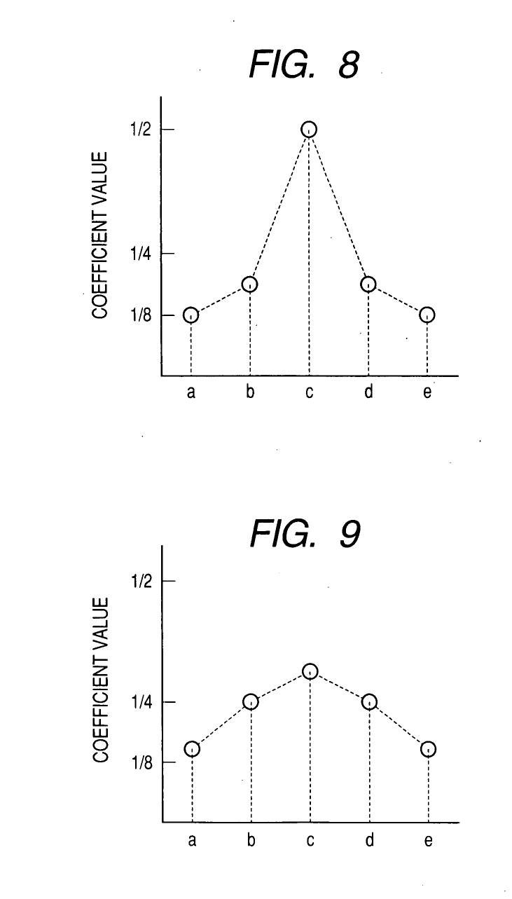

In FIG. 3 in the first embodiment, the coefficients are the same and are effective coefficients for taking the motion amount small if comparatively large pan is executed. In contrast, in FIG. 8, coefficients are set so as to take the motion amount large even in small pan. Coefficient setting in FIG. 9 is intermediate coefficient setting between FIGS. 3 and 8.

Since desired coefficients can be thus set, the coefficients are set according to tradeoff with a failure of a double image as the visual sense described above, whereby any desired setting can be made.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A Y/C separation apparatus for executing a Y/C separation based on a difference between frames of a composite video signal, the Y/C separation apparatus comprising:
a motion detection unit that specifies a motion amount based on an amount of a two-frame difference or one-frame difference at a target pixel; and
a determination unit that determines if an image is still based on a motion detection result of the motion detection unit;
wherein the motion detection unit detects differences for pixels adjacent to the target pixel.

2. The apparatus according to claim 1,
wherein the determination unit determines a minimum value of the differences as the motion amount.

3. A Y/C separation apparatus for executing Y/C separation based on a difference between frames of a composite video signal, the Y/C separation apparatus comprising:
a motion detection unit that specifies a motion amount based on an amount of a two-frame difference or one-frame difference at a target pixel; and
a determination unit that determines if an image is still based on a motion detection result of the motion detection unit;
wherein the motion detection unit detects weighted differences for pixels adjacent to the target pixel; and
the determination unit determines a minimum value of the weighted differences as the motion amount.

4. A Y/C separation apparatus for executing Y/C separation based on a difference between frames of a composite video signal, the Y/C separation apparatus comprising:
a motion detection unit that specifies a motion amount based on an amount of a two-frame difference or one-frame difference at a target pixel; and
a determination unit that determines if an image is still based on a motion detection result of the motion detection unit;
wherein the motion detection unit detects differences for pixels adjacent to the target pixel; and
the determination unit determines a weighted minimum value of the differences as the motion amount.
